(19) United States
(12) Patent Application Publication
(10) Pub. No.: US 2006/0051004 A1
(43) Pub. Date: Mar. 9, 2006

(54) Ceramic bearing assembly

(76) Inventor: Yu Hao Lee, Taichung County (TW)

Correspondence Address: CHARLES E. BAXLEY, ESQ., 90 JOHN STREET, THIRD FLOOR, NEW YORK, NY, 10038, US

(21) Appl. No.: 10/938,939

(22) Filed: Sep. 9, 2004

(51) Int. Cl. F16C 19/00; F16C 33/18; F16C 33/20

(52) U.S. Cl. 384/297

(57) ABSTRACT

A ceramic bearing assembly includes an outer barrel having an inner wall formed with an axial receiving hole, an inner barrel rotatably mounted in the receiving hole of the outer barrel and having an inner wall formed with an axial shaft hole, a first retaining ring mounted in the receiving hole of the outer barrel and rested on a first side of the inner barrel, and a second retaining ring mounted in the receiving hole of the outer barrel and rested on a second side of the inner barrel. Thus, the outer barrel is rotated on the shaft smoothly and stably without producing deviation during rotation, thereby enhancing the lifetime of the ceramic bearing assembly.

### BACKGROUND OF THE INVENTION

1. Field of the Invention

The present invention relates to a ceramic bearing assembly, and more particularly to a ceramic bearing assembly that is operated smoothly and stably.

2. Description of the Related Art

A bearing is usually mounted between two elements, so that the two elements are rotatable relative to each other smoothly. A conventional bearing comprises an axial bearing, a radial bearing, a ball bearing, a roll bearing or the like. The conventional bearing is often made of metallic material. The closest prior art references of the conventional metallic bearing are disclosed in U.S. Pat. No. 5,997,265 and U.S. Pat. No. 5,927,859.

Another conventional bearing is made of ceramic material which has greater strength, wear resistance, heat resistance, hardness, erosion resistance, magnetism resistance, self lubrication and insulation. In addition, the ceramic material has a smaller specific gravity. The closest prior art references of the conventional ceramic bearing are disclosed in U.S. Pat. No. 6,702,466-B2 and U.S. Pat. No. 6,678,956-B2.

### SUMMARY OF THE INVENTION

The primary objective of the present invention is to provide a ceramic bearing assembly that is operated smoothly and stably.

Another objective of the present invention is to provide a ceramic bearing assembly that is composed of the outer barrel and the inner barrel, so that the ceramic bearing assembly has a simplified construction, thereby facilitating fabrication and assembly of the ceramic bearing assembly.

A further objective of the present invention is to provide a ceramic bearing assembly that has a simplified construction, so that the ceramic bearing assembly is made easily and conveniently, thereby decreasing costs of fabrication.

A further objective of the present invention is to provide a ceramic bearing assembly, wherein the inner barrel is mounted between the outer barrel and the shaft and located between the first retaining ring and the second retaining ring, so that the outer barrel is rotated on the shaft smoothly and stably.

A further objective of the present invention is to provide a ceramic bearing assembly, wherein the outer barrel is rotated on the shaft smoothly and stably without producing deflection or deviation during rotation, thereby enhancing the lifetime of the ceramic bearing assembly.

In accordance with the present invention, there is provided a ceramic bearing assembly, comprising:
an outer barrel having an inner wall formed with an axial receiving hole;
an inner barrel rotatably mounted in the receiving hole of the outer barrel and having an inner wall formed with an axial shaft hole;
a first retaining ring mounted in the receiving hole of the outer barrel and rested on a first side of the inner barrel; and
a second retaining ring mounted in the receiving hole of the outer barrel and rested on a second side of the inner barrel.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a ceramic bearing assembly in accordance with the preferred embodiment of the present invention;

FIG. 2 is an exploded perspective view of the ceramic bearing assembly as shown in FIG. 1;

FIG. 3 is a plan cross-sectional view of the ceramic bearing assembly as shown in FIG. 1; and

FIG. 4 is a schematic operational view of the ceramic bearing assembly as shown in FIG. 3.

### DETAILED DESCRIPTION OF THE INVENTION

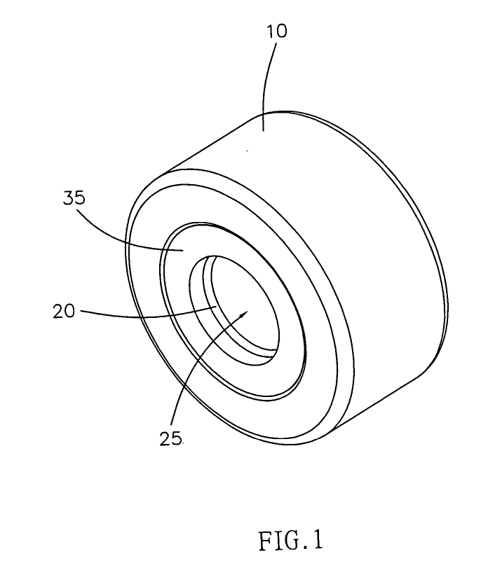

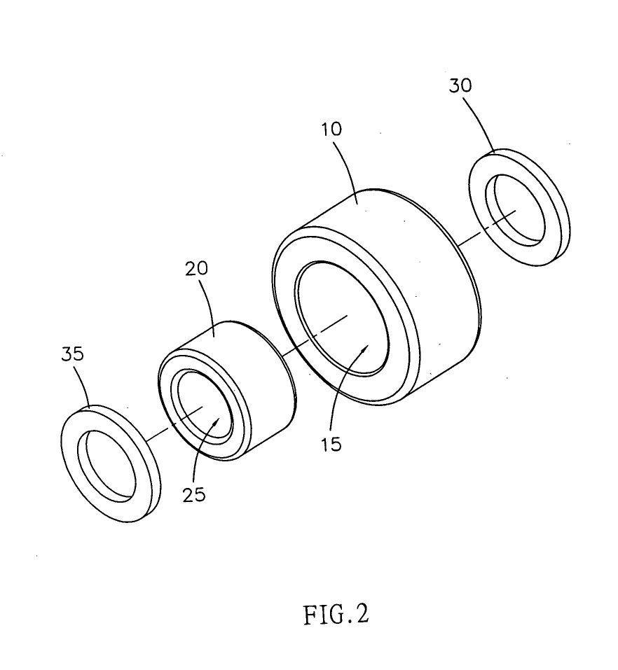

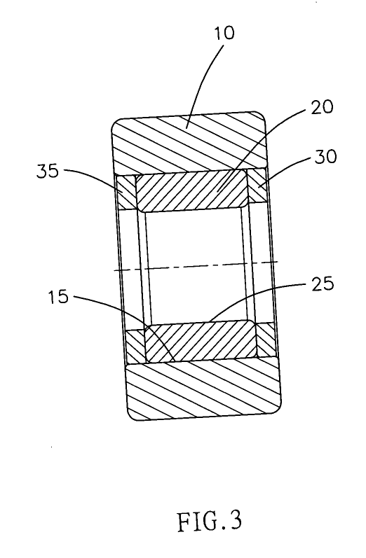

Referring to the drawings and initially to FIGS. 1-3, a ceramic bearing assembly in accordance with the preferred embodiment of the present invention comprises an outer barrel 10 having an inner wall formed with an axial receiving hole 15, an inner barrel 20 rotatably mounted in the receiving hole 15 of the outer barrel 10 and having an inner wall formed with an axial shaft hole 25, a first retaining ring 30 mounted in the receiving hole 15 of the outer barrel 10 and rested on a first side of the inner barrel 20, and a second retaining ring 35 mounted in the receiving hole 15 of the outer barrel 10 and rested on a second side of the inner barrel 20.

Each of the outer barrel 10 and the inner barrel 20 is made of ceramic material. Preferably, the outer barrel 10 has an outer wall having a cylindrical shape, a rectangular column shape or a polygonal column shape so as to fit different elements. The receiving hole 15 of the outer barrel 10 has a circular cross-section.

The inner barrel 20 has an outer wall having a cylindrical shape. When the inner barrel 20 is inserted into the receiving hole 15 of the outer barrel 10, a gap is defined between the inner wall of the outer barrel 10 and the outer wall of the inner barrel 20. Preferably, the gap defined between the inner wall of the outer barrel 10 and the outer wall of the inner barrel 20 is ranged between 0.005 mm and 0.05 mm, and is optimally ranged between 0.002 m and 0.02 mm, so that the inner barrel 20 is rotatable relative to the outer barrel 10 smoothly. Preferably, the shaft hole 25 of the inner barrel 20 has a cylindrical shape, a rectangular column shape or a polygonal column shape.

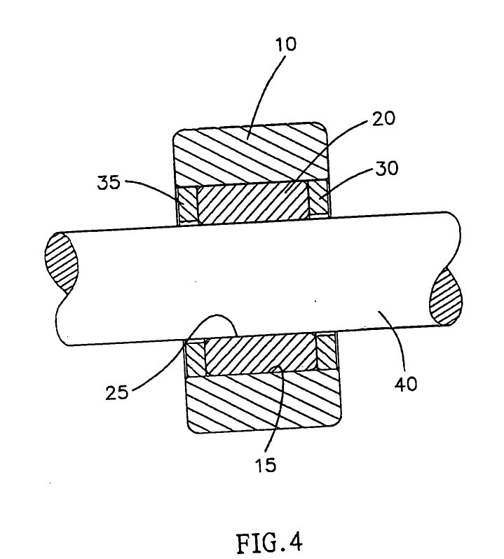

As shown in FIG. 4, a shaft 40 is mounted in the shaft hole 25 of the inner barrel 20.

In addition, when the first retaining ring 30 is mounted in the receiving hole 15 of the outer barrel 10, a gap is defined between the first side of the inner barrel 20 and a side of the first retaining ring 30, thereby preventing the first retaining ring 30 from interfering with rotation between the inner barrel 20 and the outer barrel 10.

In addition, when the second retaining ring 35 is mounted in the receiving hole 15 of the outer barrel 10, a gap is defined between the second side of the inner barrel 20 and a side of the second retaining ring 35, thereby preventing the second retaining ring 35 from interfering with rotation between the inner barrel 20 and the outer barrel 10.

Accordingly, the ceramic bearing assembly is composed of the outer barrel 10 and the inner barrel 20, so that the ceramic bearing assembly has a simplified construction, thereby facilitating fabrication and assembly of the ceramic bearing assembly. In addition, the ceramic bearing assembly has a simplified construction, so that the ceramic bearing assembly is made easily and conveniently, thereby decreasing costs of fabrication. Further, the inner barrel 20 is mounted between the outer barrel 10 and the shaft 40 and located between the first retaining ring 30 and the second retaining ring 35, so that the outer barrel 10 is rotated on the shaft 40 smoothly and stably. Further, the outer barrel 10 is rotated on the shaft 40 smoothly and stably without producing deflection or deviation during rotation, thereby enhancing the lifetime of the ceramic bearing assembly.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. A ceramic bearing assembly, comprising:
an outer barrel having an inner wall formed with an axial receiving hole;
an inner barrel rotatably mounted in the receiving hole of the outer barrel and having an inner wall formed with an axial shaft hole;
a first retaining ring mounted in the receiving hole of the outer barrel and rested on a first side of the inner barrel; and
a second retaining ring mounted in the receiving hole of the outer barrel and rested on a second side of the inner barrel.

2. The ceramic bearing assembly in accordance with claim 1, wherein each of the outer barrel and the inner barrel is made of ceramic material.

3. The ceramic bearing assembly in accordance with claim 1, wherein a gap is defined between the inner wall of the outer barrel and the outer wall of the inner barrel.

4. The ceramic bearing assembly in accordance with claim 3, wherein the gap defined between the inner wall of the outer barrel and the outer wall of the inner barrel is ranged between 0.005 mm and 0.05 mm.

5. The ceramic bearing assembly in accordance with claim 3, wherein the gap defined between the inner wall of the outer barrel and the outer wall of the inner barrel is optimally ranged between 0.002 m and 0.02 mm.

6. The ceramic bearing assembly in accordance with claim 5, wherein the inner barrel is rotatable relative to the outer barrel smoothly.

7. The ceramic bearing assembly in accordance with claim 1, wherein a gap is defined between the first side of the inner barrel and a side of the first retaining ring, thereby preventing the first retaining ring from interfering with rotation between the inner barrel and the outer barrel.

8. The ceramic bearing assembly in accordance with claim 1, wherein a gap is defined between the second side of the inner barrel and a side of the second retaining ring, thereby preventing the second retaining ring from interfering with rotation between the inner barrel and the outer barrel.

9. The ceramic bearing assembly in accordance with claim 1, further comprising a shaft mounted in the shaft hole of the inner barrel.

10. The ceramic bearing assembly in accordance with claim 1, wherein the outer barrel has an outer wall having a cylindrical shape.

11. The ceramic bearing assembly in accordance with claim 1, wherein the outer barrel has an outer wall having a rectangular column shape.

12. The ceramic bearing assembly in accordance with claim 1, wherein the outer barrel has an outer wall having a polygonal column shape.

13. The ceramic bearing assembly in accordance with claim 1, wherein the receiving hole of the outer barrel has a circular cross-section.

14. The ceramic bearing assembly in accordance with claim 1, wherein the inner barrel has an outer wall having a cylindrical shape.

15. The ceramic bearing assembly in accordance with claim 1, wherein the shaft hole of the inner barrel has a cylindrical shape.

16. The ceramic bearing assembly in accordance with claim 1, wherein the shaft hole of the inner barrel has a rectangular column shape.

17. The ceramic bearing assembly in accordance with claim 1, wherein the shaft hole of the inner barrel has a polygonal column shape.

18. The ceramic bearing assembly in accordance with claim 9, wherein the inner barrel is mounted between the outer barrel and the shaft and located between the first retaining ring and the second retaining ring.
